(19) United States
(12) Patent Application Publication
(10) Pub. No.: US 2012/0313450 A1
(43) Pub. Date: Dec. 13, 2012

(54) METHOD AND APPARATUS FOR TRANSMITTING MULTI-RADIO POWER USING TIME DIVISION MODE

(75) Inventors: Sang Wook Nam, Seoul (KR); Jong Min Park, Jeollanam-do (KR); Youn Do Tak, Seoul (KR); Yoon Goo Kim, Seoul (KR)

(73) Assignee: SNU R&DB FOUNDATION, Seoul (KR)

(21) Appl. No.: 13/578,851

(22) PCT Filed: Feb. 16, 2011
(86) PCT No.: PCT/KR2011/001025

§ 371 Date: Aug. 14, 2012

(30) Foreign Application Priority Data
Feb. 16, 2010 (KR) 10-2010-0013713

(51) Int. Cl. H02J 17/00

(52) U.S. Cl. 307/104

(57) ABSTRACT

A method for multiple wireless power transfer, capable of transmitting power wirelessly to multiple receivers, by using a time division scheme, includes the steps of: (a) allotting exclusive power transmission time for at least one of the multiple receivers; and (b) transmitting the power wirelessly to each of the at least one of the receivers; wherein, during the exclusive power transmission time allotted to an i-th receiver, which is one of the multiple receivers, the receiving state of the i-th receiver is set to ON and those of the other receivers to OFF. In accordance with the present invention, the following effects can be achieved: the PTE of the multiple receivers may be increased and the PTE of each of the receivers may be kept similarly because the power is transmitted only to one receiver by using the time division scheme and thus interference among multiple receivers is eliminated.

### FIELD OF THE INVENTION

The present invention relates to a method and a system for multiple wireless power transfer using a time division scheme; and more particularly, to multiple wireless power transfer method and system for allotting an exclusive power transmission time to each of multiple receivers and transmitting power wirelessly by setting only a receiving state of a specific receiver to ON during the power transmission time allotted to the specific receiver.

### BACKGROUND OF THE INVENTION

Recently, a lot of studies on technologies for wireless power transfer have been conducted and a technology for transmitting power wirelessly in near field range by using a principle including resonance, etc. has been already introduced.

However, if power is transmitted wirelessly to multiple receivers, interference may arise among adjacent receivers. Therefore, it is difficult to transmit power to multiple receivers with high power transmission efficiency and it is also difficult to control to make the difference in the power transmission efficiency among the respective receivers become small.

FIG. 1 represents power transmission efficiency (PTE) if power is transmitted to multiple receivers according to the prior art. More specifically, FIG. 1 expresses the sum and the difference of PTE of two receivers if the power is simultaneously transmitted wirelessly to the two receivers, wherein a square dots graph 110 indicates the sum of PTE of the two receivers and a round dots graph 120 indicates the absolute value of the difference of PTE thereof. By referring to the prior art of FIG. 1, the distance between a transmitter and a first receiver was set to be 0.15 m and that between the transmitter and a second receiver was set to be 0.10 m.

By referring to FIG. 1, it can be confirmed that total power transmission efficiency 110, i.e., the sum of the total power transmission efficiency of the first and the second receivers, appears to be high partially at roughly 13.5 MHz, 13.9 MHz and 15 MHz and it is not high on the whole with high deviations according to frequency ranges. By referring to FIG. 1, it can be also identified that the difference between the respective receivers 120 in PTE, i.e., the absolute value of the difference between the first and the second receivers in the PTE, has a value much greater than zero within a large part of frequency ranges. This means only the PTE of either the first or the second receiver is high and the PTE of each receiver is not uniformly kept.

As shown above, according to the conventional technology for multiple wireless power transfer, there were problems that the whole PTE becomes reduced and even the PTE of each receiver is not uniform. Accordingly, the method and the system for transmitting power wirelessly are necessary to be developed to achieve the high PTE of the multiple receivers and to distribute the PTE of each receiver uniformly.

### SUMMARY OF THE INVENTION

It is an object of the present invention to solve all the problems mentioned above.

It is another object of the present invention to remove any influence due to interference among multiple receivers at the time of transmitting power wirelessly thereto by setting to the singular number the number of receivers to which power is transmitted at the same time in use of a time division scheme.

In accordance with one aspect of the present invention, there is provided a method for multiple wireless power transfer, capable of transmitting power wirelessly to multiple receivers, by using a time division scheme, including the steps of: (a) allotting exclusive power transmission time for at least one of the multiple receivers; and (b) transmitting the power wirelessly to each of the at least one of the receivers; wherein, during the exclusive power transmission time allotted to an i-th receiver, which is one of the multiple receivers, the receiving state of the i-th receiver is set to ON and those of the other receivers to OFF.

In accordance with one aspect of the present invention, there is provided a transmitter included in a multiple wireless power transfer system, capable of transmitting power wirelessly to multiple receivers by using a time division scheme, including: a time division part for allowing a receiving state of an i-th receiver, which is one of the multiple receivers, to be set to ON and receiving states of the other receivers to be set to OFF during exclusive power transmission time allotted to the i-th receiver by allotting the exclusive power transmission time to each of the at least one of multiple receivers; and a wireless power transmission part for transmitting power wirelessly to each of the at least one of the multiple receivers. In accordance with one aspect of the present invention, there is provided multiple receivers, included in a multiple wireless power transfer system, capable of receiving power wirelessly from a transmitter by using a time division scheme, each including: a receiving state controlling part for controlling a receiving state of a specific receiver among the multiple receivers to be set to ON during exclusive power transmission time allotted to the specific receiver and the receiving state of the specific receiver to be set to OFF during the time except the exclusive power transmission time allotted to the specific receiver; and a switching part for shorting a switching circuit connected with load impedance to make it operated at an ON state and opening the switching circuit to make it operated at an OFF state.

### BRIEF DESCRIPTION OF THE DRAWINGS

FIG. 1 is a drawing representing power transmission efficiency (PTE), if power is wirelessly transmitted to multiple receivers according to the prior art.

FIGS. 2, 3 and 4 are drawings exemplarily showing a configuration of a multiple wireless power transfer system 200 in accordance with one example embodiment of the present invention.

FIG. 5 is a diagram exemplarily illustrating an equivalent model of a receiver according to a receiving state thereof in accordance with one example embodiment of the present invention.

FIG. 6 is a diagram exemplarily showing a procedure for operating the multiple wireless power transfer system 200 in accordance with one example embodiment of the present invention.

FIG. 7 is a drawing exemplarily representing a configuration of a transmitter and a receiver used to perform this experiment.

FIGS. 8 and 9 are diagrams illustrating the PTE of a first receiver measured if power is transmitted wirelessly to two receivers.

FIGS. 10 and 11 are diagrams representing the PTE of a second receiver measured if the power is transmitted wirelessly to the two receivers.

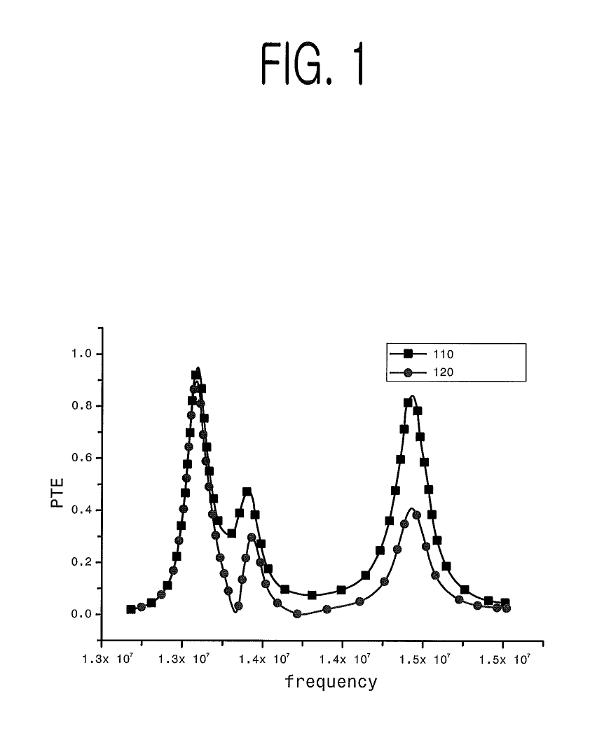

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows: □

Configuration of Multiple Wireless Power Transfer system

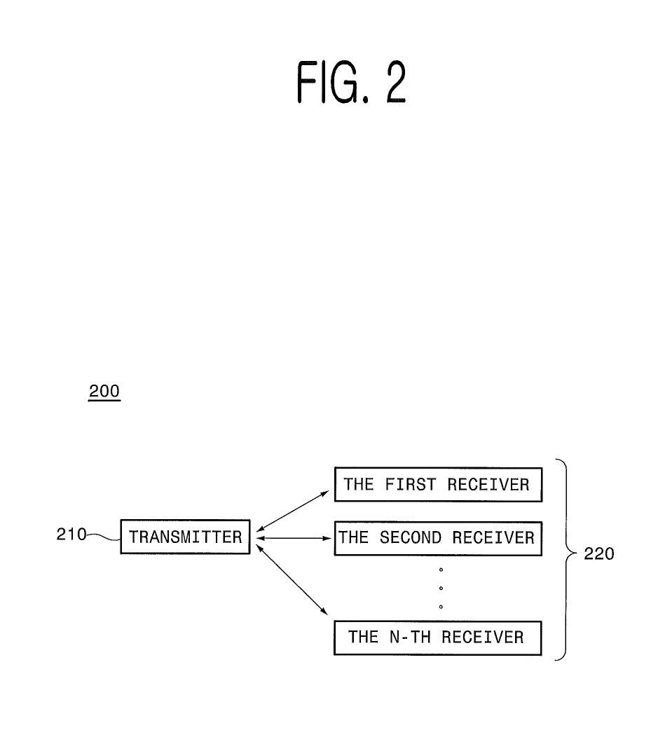

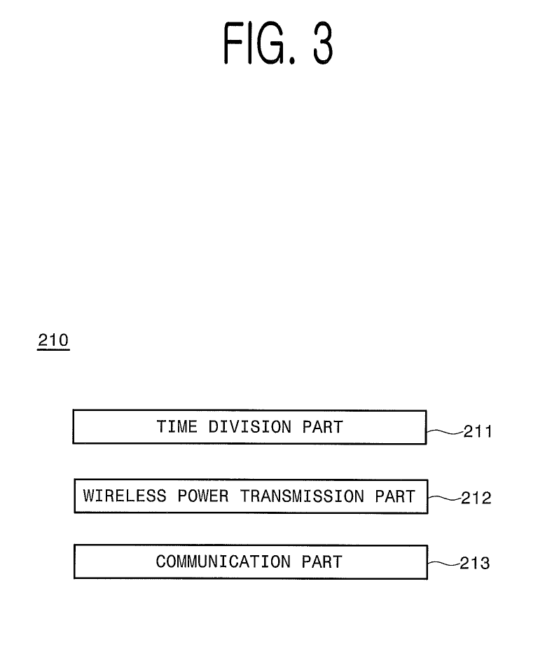

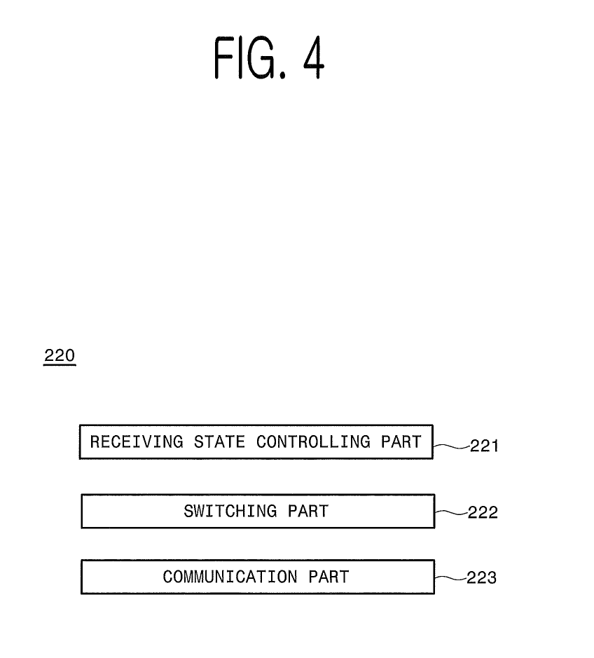

FIGS. 2, 3 and 4 exemplarily represent a configuration of a multiple wireless power transfer system 200 in accordance with one example embodiment of the present invention.

By referring to FIGS. 2, 3 and 4, the multiple wireless power transfer system 200 may include a transmitter 210 and a receiver 220, and more specifically, the transmitter 210 may include a time division part 211, a wireless power transmission part 212 and a communication part 213 and the receiver 220 may contain a receiving state controlling part 221, a switching part 222 and a communication part 223. In accordance with one example embodiment of the present invention, the multiple wireless power transfer system 200 may transmit power only to one receiver 220 at the same time by using a time division scheme, and more specifically, it may allot an exclusive power transmission time to each of the multiple receivers 220 and wirelessly transmit the power to an i-th receiver while it sets only the receiving state of the i-th receiver to ON and the receiving states of the other receivers to OFF during the power transmission time allotted to the i-th receiver.

After the detailed explanation on components of the transmitter 210 of the multiple wireless power transfer system 200 is made, each component of the receiver 220 will be explained at length.

First of all, the time division part 211 of the transmitter 210 in accordance with one example embodiment of the present invention may perform a function of dividing power transmission time for the multiple receivers 220 and allotting the divided respective power transmission time, i.e., each exclusive power transmission time, to each of the receivers 220. As explained later, during a power transmission time exclusively allotted to a specific receiver, only the receiving state of the specific receiver may be set to ON and the receiving states of the other receivers to OFF by the time division part 211 in accordance with one example embodiment of the present invention. In short, the wireless power transmission is made exclusively between the transmitter 210 and the i-th receiver during the power transmission time allotted to the i-th receiver.

More specifically, the time division part 211 in accordance with one example embodiment of the present invention may search the multiple receivers 220 within a scope of wireless power transmission of the transmitter 210, allot each power transmission time exclusively to each of the searched multiple receivers 220, and create each code including information on the exclusive power transmission time. As such, the created code may be transmitted to each of the multiple receivers 220 through the communication part 213.

It is evident that the time division part 211, in accordance with one example embodiment of the present invention, may allot the exclusive power transmission time only to some of the multiple receivers 220 within the scope of wireless power transmission of the transmitter 210.

Next, the wireless power transmission part 212 of the transmitter 210 in accordance with one example embodiment of the present invention may perform a function of transmitting the power wirelessly to the multiple receivers 220, and more specifically, transmitting the power wirelessly to the multiple receivers 220 by using a resonant frequency between the transmitter 210 and the receivers 220.

As explained above, in accordance with one example embodiment of the present invention, because only the receiving state of only one receiver 220 is at the same time set to ON, the power transmission by the wireless power transmission part 212 is made while the transmitter 210 and the receiver 220 are paired in one on one at any time zone.

If the transmitter 210 and the receiver 220 are coupled strongly in a closed space, the resonant frequency between the transmitter 210 and the receiver 220 may be analyzed by the Coupled Mode Theory (CMT), under which the resonant frequency may be divided into even and odd modes when the transmitter 210 and the receiver 220 are coupled. This may be expressed in the following equation:

$$ω = \frac{{ω}_{1} + {ω}_{2}}{2} \pm \sqrt{{\vert \frac{{ω}_{1} - {ω}_{2}}{2} \vert}^{2} + {\vert k \vert}^{2}} \qquad Equation 1$$

where ω is a resonant frequency; ω₁ and ω₂ are resonant frequencies of the transmitter 210 and the receiver 220, respectively; and k indicates a coupling constant.

When the distance between paired resonators, i.e., the transmitter 210 and the receiver 220, is changed, a value of mutual inductance and the value of the coupling constant k become changed. According to Equation 1, such changes result in the change of resonant frequency ω between the transmitter 210 and the receiver 220. If the frequency used for the wireless power transmission is fixed, even the PTE could not but to be changed and in most cases, the PTE are reduced.

Hereupon, the wireless power transmission part 212 in accordance with one example embodiment of the present invention may also perform a function of allowing the transmitter 210 and the receiver 220 to be resonated by adaptively adjusting the frequency of the wireless power transmission to allow the frequency to be coincided with the resonant frequency in order to prevent the PTE from dropping and keep the PTE all the time at the high level irrespective of the change in the distance between the transmitter 210 and the receiver 220, i.e., a degree of coupling between the transmitter 210 and the receiver 220.

More specifically, the wireless power transmission part 212 in accordance with one example embodiment of the present invention may measure an amplitude or a phase of a reflected wave of a signal fed to an input of the transmitter 210 and judge whether the current frequency of the wireless power transmission is coincided with the resonant frequency, i.e., whether the transmitter 210 and the receiver 220 are resonated.

As the result of the judgment, when the frequency of the wireless power transmission is not coincided with the resonant frequency, i.e., when resonance is judged not to be made between the transmitter 210 and the receiver 220, the wireless power transmission part 212 in accordance with one example embodiment of the present invention may coincide the frequency of the wireless power transmission with the resonant frequency by controlling the amplitude of direct current voltage (DCV) fed to the transmitter 210 and synchronizing the phase in use of phase locked loop (PLL).

Furthermore, the wireless power transmission part 212 in accordance with one example embodiment of the present invention may adaptively adjust the frequency of the wireless power transmission to be coincided with odd-mode resonant frequency if the distance between the transmitter 210 and the receiver 220 is close, i.e., if the transmitter 210 and the receiver 220 are strongly coupled.

It is made clear that the wireless power transmission method performed by the wireless power transmission part 212 in accordance with the present invention is not limited to the exemplary method as mentioned above and any methods for transferring wireless power in use of inductive coupling, capacitive coupling, antenna resonance, etc. may be considered as wireless power transmission methods in accordance with the present invention.

Next, the detailed explanation on the components of the receivers 220 in accordance with one example embodiment of the present invention is made.

The receiving state controlling part 221 of the receivers 220 in accordance with one example embodiment of the present invention may perform a function of controlling to set the receiving state of each receiver to ON or OFF by referring to the power transmission time allotted by the time division part 211.

As explained above, the receiving state controlling part 221 in accordance with one example embodiment of the present invention may receive a code including information on the exclusive power receiving time of the receiver from the transmitter 210 through the communication part 223 and control the receiving state of the receiver by referring to the code.

In accordance with one example embodiment of the present invention, the receiving state of the receiver 220 may be set by shorting or opening a switching circuit connected with a load impedance of the receiver 220 and such a switching operation of the circuit may be performed by the switching part 222 whose operation is controlled by the receiving state controlling part 221. More specifically, if the receiving state is determined to be ON by the receiving state controlling part 221, the switching part 222 in accordance with one example embodiment of the present invention may short the switching circuit connected to the load impedance to allow the power to be transmitted wirelessly from the transmitter 210 to the receiver, and if the receiving state is determined to be OFF by the receiving state controlling part 221, it may open the switching circuit connected to the load impedance to prevent the power from being transmitted from the transmitter 210 to the receiver.

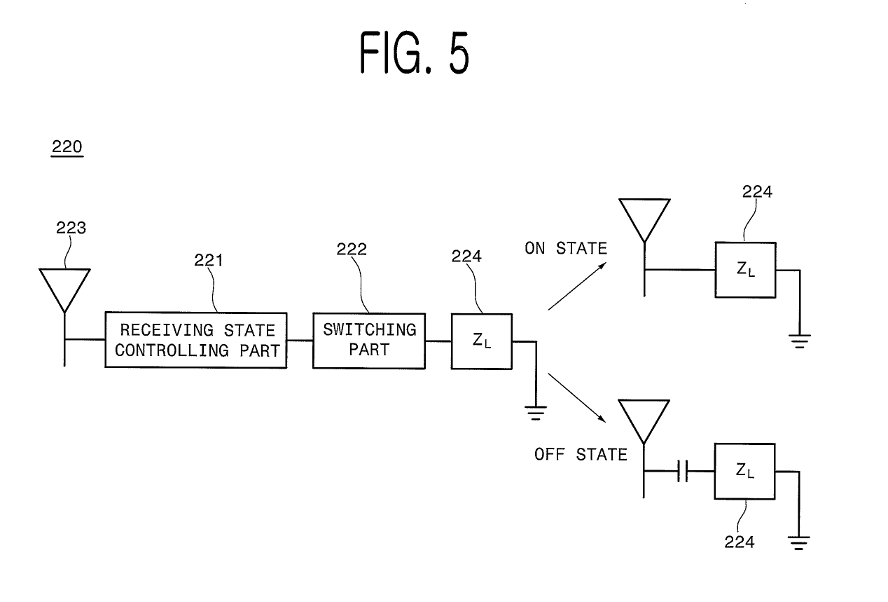

FIG. 5 exemplarily shows an equivalent model of the receiver according to the receiving state of the receiver in accordance with one example embodiment of the present invention.

By referring to FIG. 5, if the receiving state is determined to be ON at a specific time zone, the receiver 220 may be equivalently shown that the switching circuit connected to the load impedance 224 is shorted and if the receiving state is determined to be OFF at the specific time zone, it may be equivalently represented that the switching circuit connected to the load impedance 224 is opened.

In accordance with the present invention, the switching part 222 is not always construed to be a switching device which simply shorts and opens the circuit. It is made clear to configure by including necessary circuit components within the scope of achieving the purpose of the present invention.

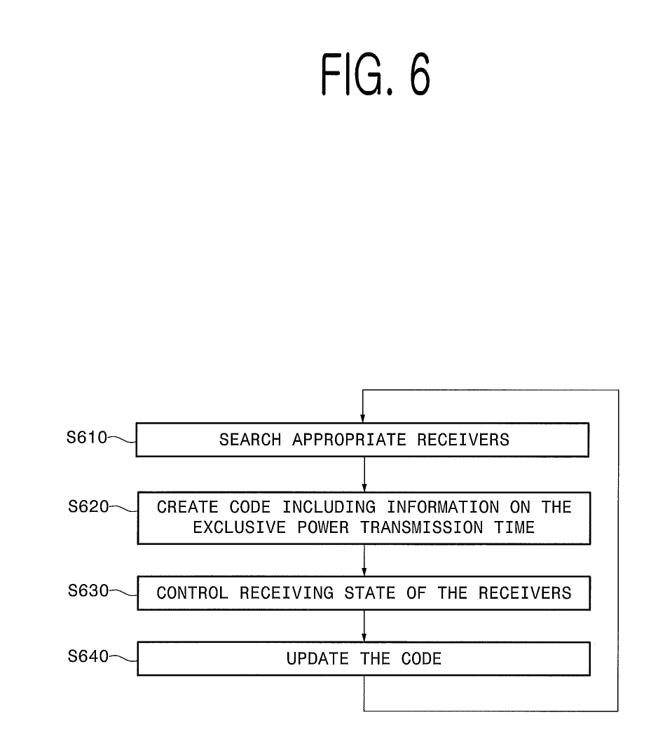

FIG. 6 exemplarily represents an operating procedure of the multiple wireless power transfer system 200 in accordance with one example embodiment of the present invention.

By referring to FIG. 6, the transmitter 210 may search the multiple receivers 220, with reference to an identifier, etc. of the receiver, within the scope of wireless power transmission (S610). Next, the transmitter 210 may allot the exclusive power transmission time for each of the multiple receivers 220 searched to be within the scope of wireless power transmission (S620). Therefor, it may create a code including information on the exclusive power transmission time to correspond to each of the multiple receivers 220 and transmit it to the multiple receivers 220. Next, each receiver 220 may control its switching part 222 according to the allotted power transmission time by referring to information included in the code transmitted from the transmitter 210 (S630). In addition, after completing the power transmission during one cycle, the transmitter 210 may periodically or non-periodically update the information on the exclusive power transmission time allotted to the multiple receivers 220 (S640).

However, the example embodiment of the operating procedure is to help the present invention understood and the multiple wireless power transfer system 200 in accordance with the present invention is not limited to the example embodiment as mentioned above and may be modified and transformed in a variety of forms within the achievable scope of the purpose of the present invention.

As explained above, in accordance with the multiple wireless power transfer system 200 of the present invention, the PTE of respective multiple receivers 220 may be increased and the PTE thereof may be kept to the equal level because power is transmitted to only one receiver regardless of a time zone by using the time division scheme and thus the interference between the multiple receivers 220 is eliminated at the time of the wireless power transmission.

Experiment Method and Result

Explained below is the result of an experiment of the power transmission efficiency (PTE) of the multiple wireless power transfer system 200 in accordance with the present invention by referring to the drawings.

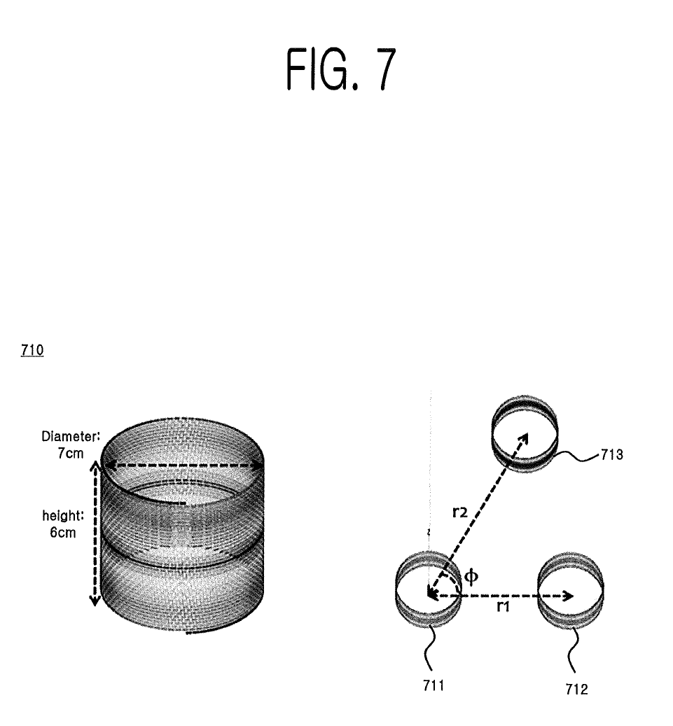

FIG. 7 exemplarily represents the configurations of the transmitter and the receiver used to perform the experiment. By reference, a spiral antenna 710 was used for a transmitter and a receiver. Herein, the height and the diameter of the spiral antenna 710 were set to be 0.06 m and 0.07 m while the load impedance and the self-resonant frequency were set to 50Ω and 13.52 MHz, respectively. In addition, the distance r1 between a transmitter 711 and a first receiver 712 was set to 0.15 m and the distance r2 between the transmitter 711 and a second receiver 713 was set to 0.20 m or 0.10 m. Based on the transmitter 711, an angle between the first receiver 712 and the second receiver 713 was set to 60°. The figures of the aforementioned antenna, including height, diameter, distance, resonant frequency, angle, load impedance, etc., will be only one example and a variety of modified figures would be applied as well.

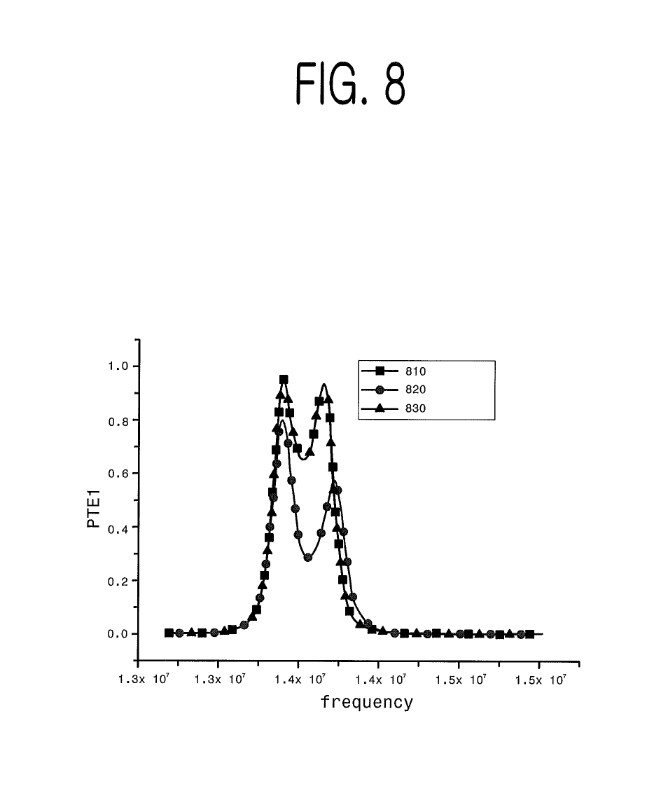

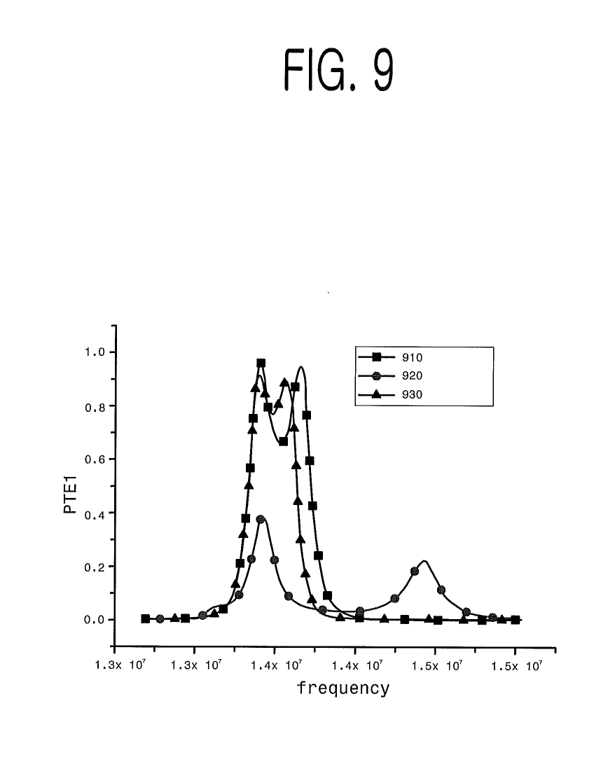

First, FIGS. 8 and 9 represent the measured PTE of the first receiver 712 when power is transmitted wirelessly to the two receivers. By reference, FIG. 8 is in the case that the distance between the transmitter 711 and the second receiver 713 is 0.20 m and FIG. 9 is in the case that the distance therebetween is 0.10 m. In addition, in FIGS. 8 and 9, the square dots graphs 810 and 910 indicate the PTE of the first receiver 712 if there is no second receiver 713 and the round dots graphs 820 and 920 indicate the PTE of the first receiver 712 when the receiving state of the second receiver 713 is ON while triangle dots graphs 830 and 930 show the PTE of the first receiver 712 when the receiving state of the second receiver 713 is OFF.

By referring to FIGS. 8 and 9, it can be confirmed that the PTE of the first receiver 712 when the receiving state of the second receiver 713 is ON in graphs 820 and 920 is apparently lower than that when there is no second receiver 713 in graphs 810 and 910. Further, it can be confirmed that when the receiving state of the second receiver 713 in graphs 830 and 930 is OFF, the PTE of the first receiver 712 appears to be as high as when there is no second receiver 713 in graphs 810 and 910. This tendency more clearly appears when the distance between the transmitter 711 and the second receiver 713 is narrower. According to the experimental result as shown in FIGS. 8 and 9, it can be evaluated that the multiple wireless power transfer system 200 in the present invention may perform the wireless power transmission between the transmitter 711 and the first receiver 712 at the high PTE by minimizing interference caused by the second receiver 713.

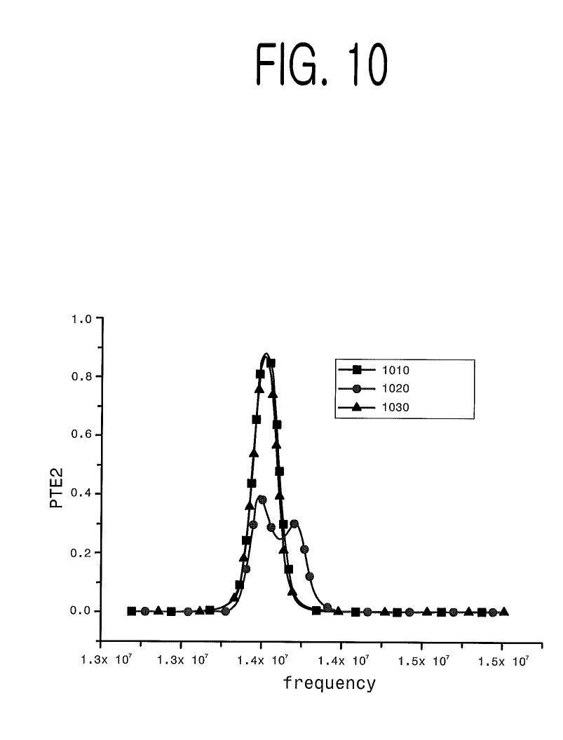

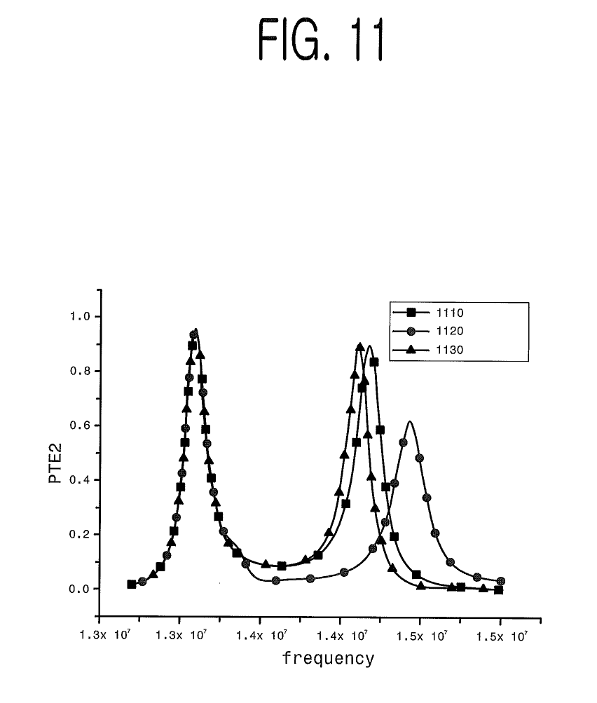

Besides, FIGS. 10 and 11 represent the PTE of the second receiver when power is transmitted to the two receivers. By reference, FIG. 10 is in the case that the distance between the transmitter 711 and the second receiver 713 is 0.20 m and FIG. 11 is in the case that the distance therebetween is 0.10 m. In FIGS. 10 and 11, the square dots graphs 1010 and 1110 indicate the PTE of the second receiver 713 if there is no first receiver 712 and the round dots graphs 1020 and 1120 indicate the PTE of the second receiver 713 when the receiving state of the first receiver 712 is ON while triangle dots graphs 1030 and 1130 shows the PTE of the second receiver 713 when the receiving state of the first receiver 712 is OFF.

By referring to FIGS. 10 and 11, it can be confirmed that the PTE of the second receiver 713 when the receiving state of the first receiver 712 is ON in graphs 1020 and 1120 is apparently lower than that when there is no first receiver 712 in graphs 1010 and 1110. Further, it can be confirmed that when the receiving state of the first receiver 712 in graphs 1030 and 1130 is OFF, the PTE of the second receiver 713 appears to be as high as when there is no first receiver 712 in graphs 1010 and 1110. This tendency more clearly appears when the distance between the transmitter 711 and the second receiver 713 is narrower. According to the experimental result as shown in FIGS. 10 and 11, it can be evaluated that the multiple wireless power transfer system 200 in the present invention may perform the wireless power transmission between the transmitter 711 and the second receiver 713 at the high PTE by minimizing interference caused by the first receiver 712.

In accordance with the present invention, the following effects can be achieved: the PTE of the multiple receivers may be increased and the PTE of each of the receivers may be kept similarly because the power is transmitted only to one receiver by using the time division scheme and thus interference among the multiple receivers is eliminated.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variation equal or equivalent to the patent claims pertain to the category of the thought of the present invention.

What is claimed is:

1. A method for multiple wireless power transfer, capable of transmitting power wirelessly to multiple receivers, by using a time division scheme, comprising the steps of:
(a) allotting exclusive power transmission time for at least one of the multiple receivers; and
(b) transmitting the power wirelessly to each of the at least one of the receivers;
wherein, during the exclusive power transmission time allotted to an i-th receiver, which is one of the multiple receivers, the receiving state of the i-th receiver is set to ON and those of the other receivers to OFF.

2. The method of claim 1, wherein the ON state is set by a switching circuit connected to load impedance included in the receiver being shorted and the OFF state is set by the switching circuit being opened.

3. The method of claim 1, wherein, at the step (a), code including information on the exclusive power transmission time for each of the at least one of receivers is created, and at the step (b), the receiving state thereof is controlled to be set to ON or OFF by referring to the code.

4. The method of claim 3, further comprising the step of: updating the code periodically or non-periodically.

5. The method of claim 1, wherein, at the step (b), a frequency of the wireless power transmission is adaptively adjusted to be coincided with a resonant frequency corresponding to each of the at least one of the receivers.

6. The method of claim 5, wherein the step (b) includes the steps of: (b1) determining whether the frequency of the wireless power transmission is coincided with the resonant frequency by referring to at least either amplitude or phase of a signal fed to an input port of a transmitter; and (b2) coinciding the frequency of the wireless power transmission with the resonant frequency by controlling the amplitude of direct current voltage or synchronizing the phase, if the frequency of the wireless power transmission is not determined to be coincided with the resonant frequency.

7. The method of claim 1, wherein, at the step (b), if the resonant frequency is divided into even and odd modes due to coupling between a transmitter and the receiver, the frequency of the wireless power transmission is adaptively adjusted to be coincided with the odd-mode resonant frequency.

8. A transmitter included in a multiple wireless power transfer system, capable of transmitting power wirelessly to multiple receivers by using a time division scheme, comprising:
a time division part for allowing a receiving state of an i-th receiver, which is one of the multiple receivers, to be set to ON and receiving states of the other receivers to be set to OFF during exclusive power transmission time allotted to the i-th receiver by allotting the exclusive power transmission time to each of the at least one of multiple receivers; and
a wireless power transmission part for transmitting power wirelessly to each of the at least one of the multiple receivers.

9. The transmitter of claim 8, wherein the time division part creates code including information on the exclusive power transmission time for each of the at least one of the multiple receivers.

10. The transmitter of claim 9, wherein the time division part updates the code periodically or non-periodically.

11. The transmitter of claim 8, wherein the wireless power transmission part adaptively adjusts a frequency of the wireless power transmission to be coincided with a resonant frequency corresponding to each of the at least one of the receivers.

12. The transmitter of claim 11, wherein the wireless power transmission part determines whether the frequency of the wireless power transmission coincides with the resonant frequency by referring to at least either amplitude or phase of a signal fed to an input port of the transmitter and coincides the frequency of the wireless power transmission with the resonant frequency by controlling the amplitude of direct current voltage or synchronizing the phase, if the frequency of the wireless power transmission is not coincided with the resonant frequency.

13. The transmitter of claim 8, wherein, if a resonant frequency is divided into even and odd modes due to coupling between the transmitter and the receiver, the wireless power transmission part adaptively adjusts the frequency of the wireless power transmission to be coincided with the odd-mode resonant frequency.

14. Multiple receivers, included in a multiple wireless power transfer system, capable of receiving power wirelessly from a transmitter by using a time division scheme, each comprising:
a receiving state controlling part for controlling a receiving state of a specific receiver among the multiple receivers to be set to ON during exclusive power transmission time allotted to the specific receiver and the receiving state of the specific receiver to be set to OFF during the time except the exclusive power transmission time allotted to the specific receiver; and
a switching part for shorting a switching circuit connected with load impedance to make it operated at an ON state and opening the switching circuit to make it operated at an OFF state.

15. The receiver of claim 14, wherein the receiving state controlling part controls the receiving state of the receivers at the ON or the OFF state by referring to code including information on the exclusive power transmission time.
